(19) United States
(12) Patent Application Publication
(10) Pub. No.: US 2023/0116555 A1
(43) Pub. Date: Apr. 13, 2023

(54) BATTERY CELL, AND BATTERY AND ELECTRONIC APPARATUS USING SUCH BATTERY CELL

(71) Applicant: Ningde Amperex Technology Limited, Ningde (CN)

(72) Inventors: Pan WANG, Ningde (CN); Zhifang DAI, Ningde (CN); Huijun LIU, Ningde (CN); Hai LONG, Ningde (CN)

(73) Assignee: Ningde Amperex Technology Limited, Ningde (CN)

(21) Appl. No.: 17/990,109

(22) Filed: Nov. 18, 2022

Related U.S. Application Data
(63) Continuation of application No. PCT/CN2021/089992, filed on Apr. 26, 2021.

(30) Foreign Application Priority Data
May 20, 2020 (CN) 202020854080.8

(51) Int. Cl. H01M 10/0587; H01M 50/531

(52) U.S. Cl. CPC H01M 10/0587; H01M 50/531

(57) ABSTRACT

A battery cell, including a first electrode plate and a second electrode plate. The first electrode plate includes a first current collector and a first active layer, the first electrode plate includes a first end portion, the first end portion is arranged on an outer side of the battery cell, and the first active layer is arranged on a surface of the first current collector in the first end portion. The first electrode plate and the second electrode plate are spaced apart and wound, and an electrode plate at the outermost circle of the battery cell is the first electrode plate. A first end face, and a first cambered zone connected to the first end face are defined. The first end portion is disposed in the first cambered zone. Also, a battery and electronic apparatus using the battery cell.

### CROSS REFERENCE TO A RELATED APPLICATION

The present application is a Continuation of PCT International Application Number PCT/CN2021/089992, filed on Apr. 26, 2021, which claims the benefit of Chinese Patent Application Number 202020854080.8, filed on May 20, 2020, the disclosure of which is hereby incorporated by reference in its entirety.

### TECHNICAL FIELD

This application relates to the field of energy storage technologies, and in particular, to a battery cell, and a battery and electronic apparatus using such battery cell.

### BACKGROUND

In conventional technology, a terminating end of an outer electrode plate of a battery cell of a spirally wound battery generally contains some uncoated aluminum foil (with no active material coating applied on either side of the foil). Such uncoated aluminum foil exposed at the outer surface of the battery cell results in lower energy density of the battery. Persons skilled in the art need to consider how a new cell structure can be provided to resolve this problem.

### SUMMARY

This application intends to resolve the problem of lower energy density of a battery cell in conventional technology caused by uncoated aluminum foil at a terminating end of a battery cell occupying volume of the battery cell. An embodiment of this application provides a battery cell, including a first electrode plate and a second electrode plate. The first electrode plate includes a first current collector and a first active layer, the first electrode plate includes a first end portion, the first end portion is arranged on an outer side of the battery cell, and the first active layer is arranged on a surface of the first current collector in the first end portion. The first electrode plate and the second electrode plate are spaced apart and wound, and an electrode plate at the outermost circle of the battery cell is the first electrode plate. A first end face and a first cambered zone connected to the first end face are defined. The first end portion is close to the first end face and disposed in the first cambered zone, where the first end face is a face that contains a most prominent point on an arc-shaped side face of the battery cell and that extends in a thickness direction of the battery cell, and the first cambered zone is a face on a side of the battery cell that is arranged in an arc shape. An embodiment of this application further provides a battery and electronic apparatus using the battery cell.

In an embodiment, the first active layer is arranged on a surface of the first current collector at the outermost circle of the battery cell that faces toward an inner side of the battery cell, and the first active layer is not provided on a surface of the first current collector on the outermost side of the battery cell.

In an embodiment, the second electrode plate includes a second current collector and a second active layer, where the second electrode plate includes a second end portion, the second end portion is close to the first end face and disposed in the first cambered zone, the second active layer is arranged on a surface of the second current collector in the second end portion, and a distance from the first end portion to the first end face is greater than a distance from the second end portion to the first end face.

In an embodiment, the battery cell further includes an insulation glue, where the insulation glue includes a first insulation sub-glue and a second insulation sub-glue, the first insulation sub-glue is provided on a surface of the first current collector in the first cambered zone, the second insulation sub-glue covers the first end portion and the second end portion, and the first insulation sub-glue is in contact with the second insulation sub-glue.

In an embodiment, the battery cell further includes a separator, where the separator is arranged between the first electrode plate and the second electrode plate, and a distance from an end of the separator to the first end face is less than the distance from the second end portion to the first end face.

In an embodiment, the first electrode plate further includes a third end portion, and the second electrode plate further includes a fourth end portion, where the third end portion and the fourth end portion are disposed in the battery cell, the battery cell further includes a tab, and the tab is disposed in the third end portion and the fourth end portion.

In an embodiment, the first active layer is not arranged on a surface of the first current collector in the third end portion, the second active layer is not arranged on a surface of the second current collector in the fourth end portion, and the insulation glue further includes a third insulation sub-glue, where the third insulation sub-glue is provided on the surface of the first current collector in the third end portion.

In an embodiment, the battery cell further includes a tab, the first electrode plate includes a first uncoated foil zone, and the second electrode plate includes a second uncoated foil zone, where in the first uncoated foil zone, the first current collector is not covered by the first active layer, the second current collector in the second uncoated foil zone is not covered by the second active layer, and the tab is disposed in the first uncoated foil zone and the second uncoated foil zone.

A battery includes the battery cell.

An electronic apparatus includes the battery.

Compared with the prior art, in the battery cell disclosed in this application, an electrode plate at the outermost circle of the battery cell is a first electrode plate with a one-side coated terminating end and without an uncoated foil zone, which can enhance an energy density of a lithium-ion battery and reduce material consumption. Moreover, a first end portion is close to the first end face and disposed in the first cambered zone, which can make full use of space between the first cambered zone and a plane of the first end face and further enhance the energy density.

### BRIEF DESCRIPTION OF DRAWINGS

FIG. 1 is a schematic planar diagram of a battery cell according to a first embodiment of this application.

FIG. 2 is a schematic cross-sectional structural diagram of the battery cell according to the first embodiment of this application.

FIG. 3 is a schematic planar diagram of a battery cell according to a second embodiment of this application.

FIG. 4 is a schematic cross-sectional structural diagram of the battery cell according to the second embodiment of this application.

FIG. 5 is a schematic planar diagram of a battery according to a third embodiment of this application.

FIG. 6 is a stereoscopic schematic diagram of an electronic apparatus according to a fourth embodiment of this application.

### REFERENCE SIGNS OF MAIN COMPONENTS

electronic apparatus 100
body 105
battery 1
battery cell 10, 20, 30
first electrode plate 11, 21
first current collector 110, 210
first active layer 119, 219
first uncoated foil zone 218
first end portion 111, 211
third end portion 113, 213
second electrode plate 12, 22
second current collector 120, 220
second active layer 129, 229
second uncoated foil zone 228
second end portion 122, 222
fourth end portion 124, 224
separator 13, 23
fifth end portion 135, 235
sixth end portion 136, 236
insulation glue 15
first insulation sub-glue 151, 251
second insulation sub-glue 152, 252
third insulation sub-glue 153
fourth insulation sub-glue 154
fifth insulation sub-glue 155
sixth insulation sub-glue 256
seventh insulation sub-glue 257
tab 16, 26
first tab 17, 27
second tab 18, 28
first end face 101, 201
first cambered zone 102, 202

This application will be further described with reference to the accompanying drawings in the following specific embodiments.

### DETAILED DESCRIPTION

The following more comprehensively describes content of this application with reference to the accompanying drawings. The accompanying drawings show example embodiments of this application. However, this application may be implemented in many different implementations and should not be construed as being limited to the example embodiments illustrated herein. These example embodiments are provided to clearly describe this application, and to fully convey the scope of this application to persons skilled in the art. Similar reference signs represent the same component or similar components.

Terms used herein are only for the purpose of describing specific example embodiments, and are not intended to limit this application. As used herein, unless otherwise clearly stated in the context, singular forms “a/an”, “one”, and “the” also are intended to include plural forms. In addition, when used herein, the singular forms “include” and/or “contain” or “comprise” and/or “involve” or “have” and/or “possess” an integer, a step, an operation, a component, and/or an assembly, but do not exclude presence or addition of one or more other features, regions, integers, steps, operations, components, assemblies, and/or groups thereof.

Unless otherwise defined, all terms (including technical and scientific terms) used herein have the same meanings as those commonly understood by persons of ordinary skills in the art to which this application pertains. In addition, unless clearly defined herein, terms such as those defined in a general dictionary should be construed as having the same meanings as the terms in related technologies and content of this application, and shall not be construed as idealized or extremely formal meanings.

The following content describes the example embodiments with reference to the accompanying drawings. It should be noted that components illustrated in the reference drawings are not necessarily shown to scale; and the same or similar reference signs or similar technical terms are used for the same or similar components.

The specific implementations of this application are further described in detail below with reference to the accompanying drawings.

### Embodiment 1

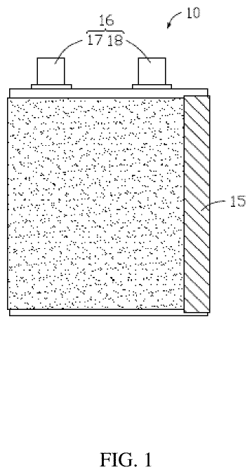

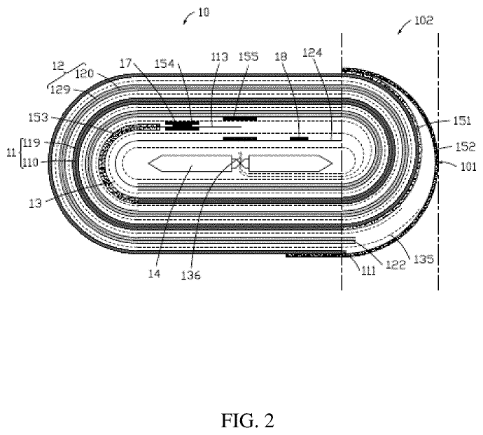

As shown in FIG. 1 and FIG. 2, a first embodiment of this application provides a battery cell 10. The battery cell 10 includes a first electrode plate 11, a second electrode plate 12, and a separator 13. The first electrode plate 11 and the second electrode plate 12 are spaced apart and stacked. The separator 13 is arranged between the first electrode plate 11 and the second electrode plate 12. In an embodiment, the first electrode plate 11 and the second electrode plate 12 may be stacked. In this embodiment, the first electrode plate 11 and the second electrode plate 12 are wound. The battery cell 10 further includes a coiling needle 14. The first electrode plate 11, separator 13, and second electrode plate 12 are sequentially spaced apart and wound around the coiling needle 14.

The first electrode plate 11 includes a first current collector 110 and a first active layer 119, and the first active layer 119 is arranged on a surface of the first current collector 110. The first electrode plate 11 includes a first end portion 111 and a third end portion 113. The first end portion 111 and the third end portion 113 are separately located at two sides of the first electrode plate 11. In an embodiment, the first end portion 111 is arranged on an outer side of the battery cell 10, the third end portion 113 is arranged in the battery cell 10, and the first active layer 119 is arranged on a surface of the first current collector 110 in the first end portion 111.

The second electrode plate 12 includes a second current collector 120 and a second active layer 129, and the second active layer 129 is arranged on a surface of the second current collector 120. The second electrode plate 12 includes a second end portion 122 and a fourth end portion 124. The second end portion 122 and the fourth end portion 124 are separately located at two sides of the second electrode plate 12. In an embodiment, the second end portion 122 is arranged on an outer side of the battery cell 10, and the fourth end portion 124 is arranged in the battery cell 10.

In an embodiment, the battery cell 10 is a wound cell. An electrode plate at the outermost circle of the battery cell 10 is the first electrode plate 11. The first active layer 119 is arranged on a surface of the first current collector 110 of an electrode plate at the outermost circle of the battery cell that faces toward an inner side of the battery cell 10, and the first active layer 119 is not arranged on a surface of the first current collector 110 of the electrode plate at the outermost circle of the battery cell 10. To be specific, an interior surface of the first electrode plate 11 that is the electrode plate at the outermost circle of the battery cell 10, is provided with the first active layer 119, which corresponds to the second active layer 129 on the second electrode plate 12, and an outer surface of the first electrode plate 11 that is the electrode plate at the outermost circle of the battery cell 10 is designed with an uncoated foil zone. Such a structure can enhance an energy density of the battery cell 10, reduce material consumption, and improve safety performance of the battery cell 10.

A first end face 101 and a first cambered zone 102 connected to the first end face 101 are defined. The first end face 101 is a face that contains a most prominent point on an arc-shaped side face of the battery cell 10 and that extends in a thickness direction of the battery cell 10, and the first cambered zone 102 is a face on a side of the battery cell 10 that is arranged in an arc shape. In an embodiment, the first end portion 111 and the second end portion 122 are close to the first end face 101 and disposed in the first cambered zone 102.

That the first end portion 111 and the second end portion 122 are located in the first cambered zone 102 means that the first electrode plate 11 and the second electrode plate 12 of the battery cell 10 are terminated and cut at an “angle R” of the battery cell 10. Such a structure can offer support to a side of the battery cell 10 to enhance flatness and overall pressure-resistant performance of the battery cell 10. Moreover, the first end portion 111 and the second end portion 122 are subject to lower pressure when being located in the first cambered zone 102 than in other zones, and a fin at a cutting end of the first electrode plate 11 or the second electrode plate 12 is more unlikely to pierce the separator 13, which can effectively reduce short circuit points in the battery cell 10, reduce energy consumption of the self-cycling of the battery cell 10, and improve battery performance. The first end portion 111 and the second end portion 122 are close to the first end face 101 and located in the first cambered zone 102, which can make full use of space between the first cambered zone 102 and a plane of the first end face 101 and further enhance the energy density.

In a direction perpendicular to the first end face 101, a distance L1 from the first end portion 111 to the first end face 101 is greater than a distance L2 from the second end portion 122 to the first end face 101. The L1 ranges from 2 mm to 8 mm, and the L2 ranges from 0 mm to 3 mm A distance between the first end portion 111 and the second end portion 122 is L3, and L3 is greater than 2 mm. In an embodiment, the first electrode plate 11 is a cathode, and the second electrode plate 12 is an anode.

The separator 13 includes a fifth end portion 135 and a sixth end portion 136. The fifth end portion 135 and the sixth end portion 136 are separately located at two ends of the separator 13. The fifth end portion 135 is arranged on an outer side of the battery cell 10, and the sixth end portion 136 is arranged in the battery cell 10 and is wound around the coiling needle 14. In an embodiment, a length of a terminating end of the separator 13 on an outer side of the battery cell 10 is longer than a length of a terminating end of the first electrode plate 11 and a length of a terminating end of the second electrode plate 12. At least two fifth end portions 135 wrap around the second end portion 122. In a direction perpendicular to the first end face 101, a distance L4 between the fifth end portion 135 and the second end portion 122 is greater than 4 mm.

The battery cell 10 further includes an insulation glue 15. The insulation glue 15 includes a first insulation sub-glue 151 and a second insulation sub-glue 152. The insulation glue 15 may be an organic insulating material, such as green glue or hot melt glue. The first insulation sub-glue 151 is provided on an outer surface of the first current collector 110 in the first cambered zone 102, the second insulation sub-glue 152 covers the first end portion 111 and the second end portion 122, the second insulation sub-glue 152 is in contact with the first insulation sub-glue 151, and the second insulation sub-glue 152 covers a part of the first insulation sub-glue 151 that is away from the first end portion 111. The first insulation sub-glue 151 and the second insulation sub-glue 152 are arranged at two sides of the first end portion 111 and the second end portion 122 (cutting ends of the electrode plate), to further prevent a fin in the first end portion 111 or the second end portion 122 from piercing the separator 13 or a packaging bag on an outer side of the battery cell 10 to cause electrolyte leakage and short circuit.

The insulation glue 15 further includes a third insulation sub-glue 153, a fourth insulation sub-glue 154, and a fifth insulation sub-glue 155. The third insulation sub-glue 153 is disposed at an uncoated foil zone in the third end portion 113, and an outermost end of the third end portion 113 is not covered by the third insulation sub-glue 153.

The battery cell 10 further includes a tab 16. The tab 16 may include a first tab 17 and a second tab 18. The first tab 17 is electrically connected to the first electrode plate 11. Specifically, the first tab 17 is formed by extending the first current collector 110. The second tab 18 is electrically connected to the second electrode plate 12. Specifically, the second tab 18 is formed by extending the second current collector 120.

In an embodiment, the first tab 17 is disposed in the third end portion 113, the fourth insulation sub-glue 154 is provided at two sides of the first tab 17 to protect the first tab 17, the fifth insulation sub-glue 155 is provided at two sides of a terminating end of the third end portion 113 and mirrored, and the second tab 18 is disposed in the fourth end portion 124.

### Embodiment 2

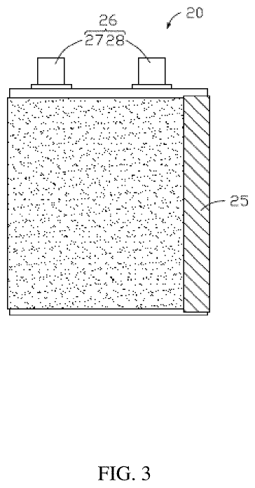

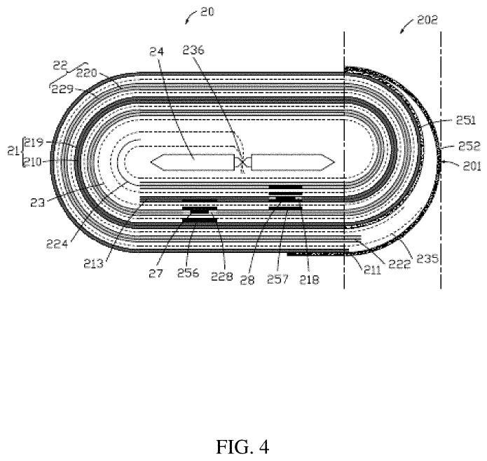

As shown in FIG. 3 and FIG. 4, a second embodiment of this application provides a battery cell 20. The battery cell 20 includes a first electrode plate 21, a second electrode plate 22, and a separator 23. The first electrode plate 21 and the second electrode plate 22 are spaced apart and stacked. The separator 23 is arranged between the first electrode plate 21 and the second electrode plate 22. In an embodiment, the first electrode plate 21 and the second electrode plate 22 may be stacked. In this embodiment, the first electrode plate 21 and the second electrode plate 22 are wound. The battery cell 20 further includes a coiling needle 24. The first electrode plate 21, separator 23, and second electrode plate 22 are sequentially spaced apart and wound around the coiling needle 24.

The first electrode plate 21 includes a first current collector 210 and a first active layer 219, and the first active layer 219 is arranged on a surface of the first current collector 210. The first electrode plate 21 includes a first end portion 211 and a third end portion 213. The first end portion 211 and the third end portion 213 are separately located at two sides of the first electrode plate 21. In an embodiment, the first end portion 211 is arranged on an outer side of the battery cell 20, the third end portion 213 is arranged in the battery cell 20, and the first active layer 219 is arranged on a surface of the first current collector 210 in the first end portion 211.

The second electrode plate 22 includes a second current collector 220 and a second active layer 229, and the second active layer 229 is arranged on a surface of the second current collector 220. The second electrode plate 22 includes a second end portion 222 and a fourth end portion 224. The second end portion 222 and the fourth end portion 224 are separately located at two sides of the second electrode plate 22. In an embodiment, the second end portion 222 is arranged on an outer side of the battery cell 20, and the fourth end portion 224 is arranged in the battery cell 20.

In an embodiment, the battery cell 20 is a wound cell. An electrode plate at the outermost circle of the battery cell 20 is the first electrode plate 21. The first active layer 219 is arranged on a surface of the first current collector 210 of an electrode plate at the outermost circle of the battery cell that faces toward an inner side of the battery cell 20, and the first active layer 219 is not arranged on a surface of the first current collector 210 on the outermost side of the battery cell 20. To be specific, an interior surface of the first electrode plate 21 that is the electrode plate at the outermost circle of the battery cell 20, is provided with the first active layer 219, which corresponds to the second active layer 229 on the second electrode plate 22, and an outer surface of the first electrode plate 21 that is the electrode plate at the outermost circle of the battery cell 20 is designed with an uncoated foil zone. Such a structure can enhance an energy density of the battery cell 20, reduce material consumption, and improve safety performance of the battery cell 20.

A first end face 201 and a first cambered zone 202 connected to the first end face 201 are defined. The first end face 201 is a face that contains a most prominent point on an arc-shaped side face of the battery cell 20 and that extends in a thickness direction of the battery cell 20, and the first cambered zone 202 is a face on a side of the battery cell 20 that is arranged in an arc shape. In an embodiment, the first end portion 211 and the second end portion 222 are close to the first end face 201 and disposed in the first cambered zone 202.

That the first end portion 211 and the second end portion 222 are located in the first cambered zone 202 means that the first electrode plate 21 and the second electrode plate 22 of the battery cell 20 are terminated and cut at an “angle R” of the battery cell 20. Such a structure can offer support to a side of the battery cell 20 to enhance flatness and overall pressure-resistant performance of the battery cell 20. Moreover, the first end portion 211 and the second end portion 222 are subject to lower pressure when being located in the first cambered zone 202 than in other zones, and a fin at a cutting end of the first electrode plate 21 or the second electrode plate 22 is more unlikely to pierce the separator 23, which can effectively reduce short circuit points in the battery cell 20, reduce energy consumption of the self-cycling of the battery cell 20, and improve battery performance. The first end portion 211 and the second end portion 222 are close to the first end face 201 and located in the first cambered zone 202, which can make full use of space between the first cambered zone 202 and a plane of the first end face 201 and further enhance the energy density.

In a direction perpendicular to the first end face 201, a distance L1 from the first end portion 211 to the first end face 201 is greater than a distance L2 from the second end portion 222 to the first end face 201. The L1 ranges from 2 mm to 8 mm, and the L2 ranges from 0 mm to 3 mm A distance between the first end portion 211 and the second end portion 222 is L3, and L3 is greater than 2 mm. In an embodiment, the first electrode plate 21 is a cathode, and the second electrode plate 22 is an anode.

The separator 23 includes a fifth end portion 235 and a sixth end portion 236. The fifth end portion 235 and the sixth end portion 236 are separately located at two ends of the separator 23. The fifth end portion 235 is arranged on an outer side of the battery cell 20, and the sixth end portion 236 is arranged in the battery cell 20 and is wound around the coiling needle 24. In an embodiment, a length of a terminating end of the separator 23 on an outer side of the battery cell 20 is longer than a length of a terminating end of the first electrode plate 21 and a length of a terminating end of the second electrode plate 22. At least two fifth end portions 235 wrap around the second end portion 222. In a direction perpendicular to the first end face 201, a distance L4 between the fifth end portion 235 and the second end portion 222 is greater than 4 mm.

The battery cell 20 further includes an insulation glue 25. The insulation glue 25 includes a first insulation sub-glue 251 and a second insulation sub-glue 252. The insulation glue 25 may be an organic insulating material, such as green glue or hot melt glue. The first insulation sub-glue 251 is provided on an outer surface of the first current collector 210 in the first cambered zone 202, the second insulation sub-glue 252 covers the first end portion 211 and the second end portion 222, the second insulation sub-glue 252 is in contact with the first insulation sub-glue 251, and the second insulation sub-glue 252 covers a part of the first insulation sub-glue 251 that is away from the first end portion 211. The first insulation sub-glue 251 and the second insulation sub-glue 252 are arranged at two sides of the first end portion 211 and the second end portion 222 (cutting ends of the electrode plate), to further prevent a fin in the first end portion 211 or the second end portion 222 from piercing the separator 23 or a packaging bag on an outer side of the battery cell 20 to cause electrolyte leakage and short circuit.

The battery cell 20 further includes a tab 26. The tab 26 may include a first tab 27 and a second tab 28. The first tab 27 is electrically connected to the first electrode plate 21. Specifically, the first tab 27 is formed by extending the first current collector 210. The second tab 28 is electrically connected to the second electrode plate 22. Specifically, the second tab 28 is formed by extending the second current collector 220.

In an embodiment, the first electrode plate 21 includes a first uncoated foil zone 218, and the second electrode plate 22 includes a second uncoated foil zone 228. The first current collector 210 in the first uncoated foil zone 218 is not covered by the first active layer 219, and the first uncoated foil zone 218 is located at an inner circle of the battery cell 20. The second current collector 220 in the second uncoated foil zone 228 is not covered by the second active layer 229, and the second uncoated foil zone 228 is located at the inner circle of the battery cell 20.

The insulation glue 25 further includes a sixth insulation sub-glue 256 and a seventh insulation sub-glue 257. The first tab 27 is disposed in the first uncoated foil zone 218, and the sixth insulation sub-glue 256 is symmetrically disposed at two sides of the first tab 27. The second tab 28 is disposed in the second uncoated foil zone 228, and the seventh insulation sub-glue 257 is symmetrically disposed at two sides of the second tab 28.

### Embodiment 3

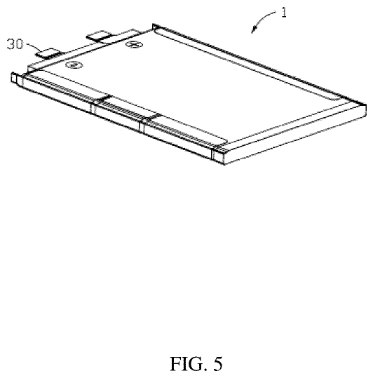

FIG. 5 is a schematic planar diagram of a battery 1 provided in a third embodiment of this application. The battery 1 includes a battery cell 30, where the battery cell 30 may be the battery cell in any one of the Embodiment 1 or Embodiment 2.

### Embodiment 4

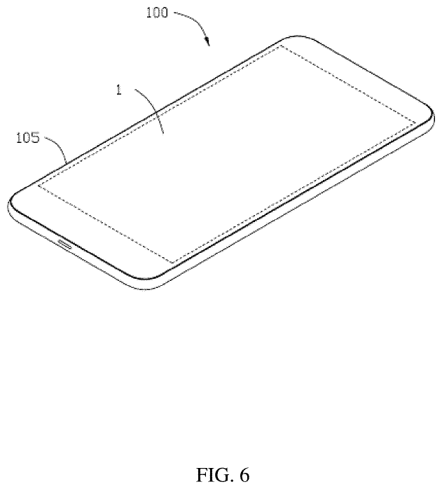

FIG. 6 is a stereoscopic schematic diagram of an electronic apparatus 100 provided in a fourth embodiment of this application.

This application further provides an electronic apparatus 100. The electronic apparatus includes a body 105 and a battery 1 disposed in the body 105, where the battery 1 includes the battery cell in the Embodiment 1 or Embodiment 2.

In FIG. 6, only a mobile phone is shown as an example of the electronic apparatus 100. In another embodiment, the electronic apparatus 100 may alternatively be a wearable device, a drone, a personal computer, a smart home appliance, an industrial controller, an energy storage apparatus, an electric tool, an electric automobile, or the like.

The foregoing describes specific implementations of this application with reference to the accompanying drawings. However, persons of ordinary skill in the art can understand that various changes and replacements can be further made to the embodiments of this application without departing from the spirit and the scope of this application. These modifications and substitutions fall within the scope of this application.

What is claimed is:

1. A battery cell, comprising:
a first electrode plate, wherein the first electrode plate comprises a first current collector and a first active layer, the first electrode plate comprises a first end portion, the first end portion is arranged on an outer side of the battery cell, and the first active layer is arranged on a surface of the first current collector in the first end portion; and
a second electrode plate, wherein the first electrode plate and the second electrode plate are spaced apart and wound, and an electrode plate at the outermost circle of the battery cell is the first electrode plate; wherein
a first end face and a first cambered zone connected to the first end face are defined, wherein the first end portion is located in the first cambered zone.

2. The battery cell according to claim 1, wherein the first active layer is arranged on a surface of the first current collector at the outermost circle of the battery cell, the surface faces toward an inner side of the battery cell, and the first active layer is not arranged on a surface of the first current collector on the outermost side of the battery cell.

3. The battery cell according to claim 1, wherein the second electrode plate comprises a second current collector and a second active layer, wherein the second electrode plate comprises a second end portion, the second end portion is located in the first cambered zone, the second active layer is arranged on a surface of the second current collector in the second end portion; in a direction perpendicular to the first end face, a distance from the first end portion to the first end face is greater than a distance from the second end portion to the first end face.

4. The battery cell according to claim 3, wherein the battery cell further comprises an insulation glue, wherein the insulation glue comprises a first insulation sub-glue and a second insulation sub-glue, the first insulation sub-glue is provided on a surface of the first current collector in the first cambered zone, the second insulation sub-glue covers the first end portion and the second end portion, and the second insulation sub-glue is in contact with the first insulation sub-glue.

5. The battery cell according to claim 3, wherein the distance from the first end portion to the first end face ranges from 2 mm to 8 mm, the distance from the second end portion to the first end face ranges from 0 mm to 3 mm, in a direction perpendicular to the first end face, a distance between the first end portion and the second end portion is greater than 2 mm.

6. The battery cell according to claim 4, wherein the second insulation sub-glue covers a part of the first insulation sub-glue, the part of the first insulation sub-glue is away from the first end portion.

7. The battery cell according to claim 4, wherein the first insulation sub-glue and the second insulation sub-glue are arranged at two sides of the first end portion and the second end portion.

8. The battery cell according to claim 3, wherein the battery cell further comprises a separator, wherein the separator is arranged between the first electrode plate and the second electrode plate, the separator comprises a fifth end portion and a sixth end portion, the fifth end portion is arranged on an outer side of the battery cell, and the sixth end portion is arranged in the battery cell, in a direction perpendicular to the first end face, a distance from the fifth end portion to the first end face is less than a distance from the second end portion to the first end face.

9. The battery cell according to claim 8, wherein a distance between the fifth end portion and the second end portion is greater than 4 mm.

10. The battery cell according to claim 8, wherein at least two fifth end portions wrap around the second end portion.

11. The battery cell according to claim 4, wherein the first electrode plate further comprises a third end portion, and the second electrode plate further comprises a fourth end portion, the battery cell further comprises a tab, and the tab is disposed in the third end portion and the fourth end portion.

12. The battery cell according to claim 11, wherein the first active layer is not arranged on a surface of the first current collector in the third end portion, the second active layer is not arranged on a surface of the second current collector in the fourth end portion, and the insulation glue further comprises a third insulation sub-glue, where the third insulation sub-glue is provided on the surface of the first current collector in the third end portion.

13. The battery cell according to claim 12, wherein the outermost end of the third end portion is not covered by the third insulation sub-glue.

14. The battery cell according to claim 12, wherein the tab comprises a first tab and a second tab, the first tab is disposed in the third end portion, and the second tab is disposed in the fourth end portion.

15. The battery cell according to claim 14, where the insulation glue further includes a fourth insulation sub-glue, the fourth insulation sub-glue is provided at two sides of the first tab.

16. The battery cell according to claim 15, where the insulation glue further includes a fifth insulation sub-glue, the fifth insulation sub-glue is provided at two sides of a terminating end of the third end portion.

17. The battery cell according to claim 3, wherein the battery cell further comprises a tab, the first electrode plate comprises a first uncoated foil zone, and the second electrode plate comprises a second uncoated foil zone; wherein in the first uncoated foil zone, the first current collector is not covered by the first active layer, the second current collector in the second uncoated foil zone is not covered by the second active layer, and the tab is disposed in the first uncoated foil zone and the second uncoated foil zone.

18. The battery cell according to claim 17, wherein the tab comprises a first tab and a second tab, the first tab is disposed in the first uncoated foil zone, the second tab is disposed in the second foil zone.

19. A battery, comprising the battery cell according to claim 1.

20. An electronic apparatus, comprising the battery according to claim 19.
